(19) United States
(12) Patent Application Publication
(10) Pub. No.: US 2025/0388090 A1
(43) Pub. Date: Dec. 25, 2025

(54) VEHICLE POWER SYSTEM AND METHOD

(71) Applicant: Dana Automotive Systems Group, LLC, Maumee, OH (US)

(72) Inventor: Frederik DESMET, Maldegem (BE)

(21) Appl. No.: 18/748,583

(22) Filed: Jun. 20, 2024

(51) Int. Cl. B60L 15/00; B60L 50/51; B60L 53/14; B60L 53/22; B60L 53/60

(52) U.S. Cl. CPC B60L 15/007; B60L 50/51; B60L 53/22; B60L 53/60; B60L 53/14; B60L 2210/10; B60L 2210/40

(57) ABSTRACT

Methods and systems for distributing electric power within an electric vehicle are described. In one example, a bi-directional power converter is operated in one mode to convert AC power to DC power. The DC power is supplied to a traction battery. The bi-directional power converter may also be operated in a second mode to convert DC power into AC power. The AC power is supplied to rotor windings of a traction motor.

### TECHNICAL FIELD

The present disclosure relates to distributing electric power in an electric vehicle.

### BACKGROUND AND SUMMARY

Electric vehicles may include several power converters to change power levels and to deliver particular types of power to power consumers. For example, the electric vehicle may include an inverter or DC/AC converter to supply alternating current (AC) to a stator of a traction motor from direct current (DC) that may be delivered via a traction battery. Further, the electric vehicle may also include an AC to DC converter to convert AC power that is supplied via electric vehicle supply equipment to DC power that is applied to charge the traction battery. Due to a desire to reduce or eliminate permanent magnets from traction motors, there may be a desire to substitute rotor windings and electrical excitation for permanent magnets in traction motors. However, such a change may lead to integration of yet another power converter into the vehicle system, thereby increasing system financial expense and complexity. Therefore, it may be desirable to provide an electric vehicle that has an electrically excited rotor without having to increase an actual total number of power converters in an electric vehicle.

The inventor herein has recognized the previously mentioned issued and has developed a vehicle power distribution system, comprising: a traction battery; a direct current to alternating current (DC/AC) power converter configured to supply three phase alternating current (AC) electric power to an armature of a traction motor rotor from the traction battery; and a bi-directional power converter configured to supply AC to a rotor winding of the traction motor in a first mode and supply direct current (DC) to the traction battery in a second mode.

By operating a bi-directional power converter in two different modes, it may be possible to provide electric power to power consumers without having to install a power converter solely for the purpose of exciting rotor windings of an electric machine. For example, the bi-directional power converter may supply AC power to rotor windings when a vehicle is being propelled via a traction motor. However, when the vehicle's traction battery is being charged, the bi-directional power converter may supply DC power to the traction battery.

The electric power distribution system that is described herein may provide several advantages. Specifically, the electric power distribution system may reduce vehicle systems financial expenses. Further, the electric power distribution system may reduce vehicle weight, thereby increasing vehicle driving range. Additionally, the approach electrically isolates rotor windings from charger AC power output.

It may be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a plan view of an example electric vehicle.

FIG. 2 shows a schematic of an example electric vehicle electric power distribution system.

FIG. 3 shows an example electric power distribution system operating sequence.

FIG. 4 shows a method for operating an electric power distribution system for an electric vehicle.

### DETAILED DESCRIPTION

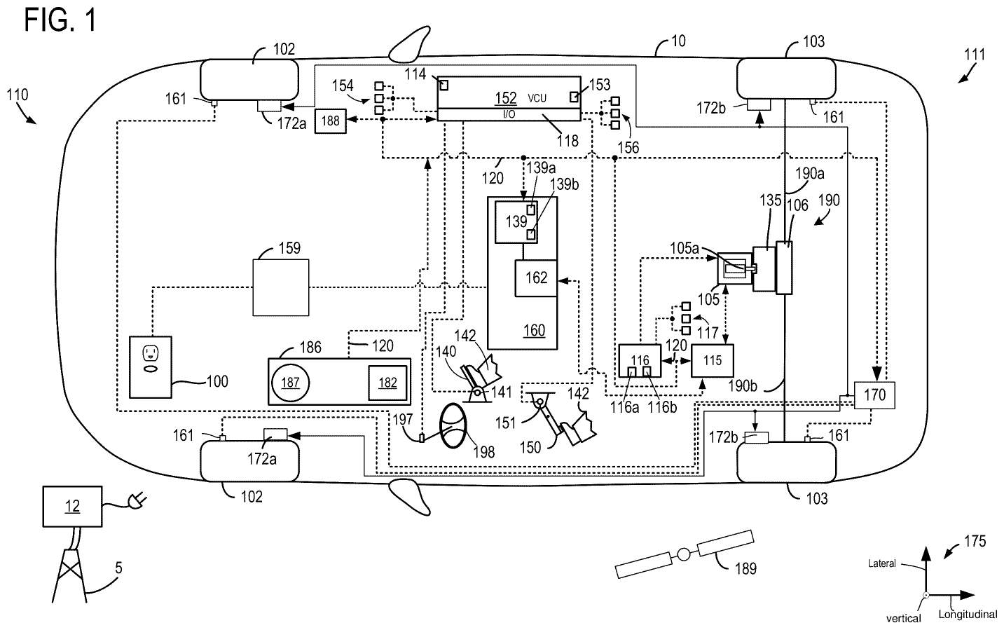

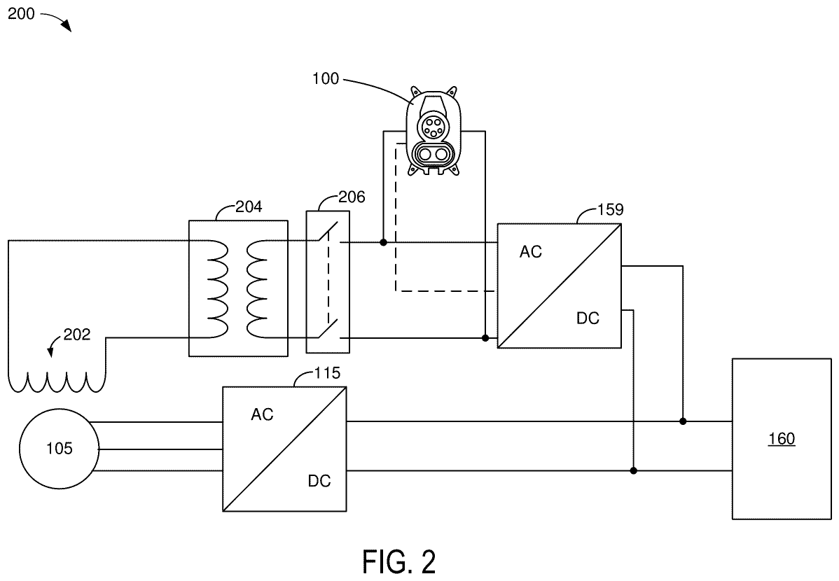

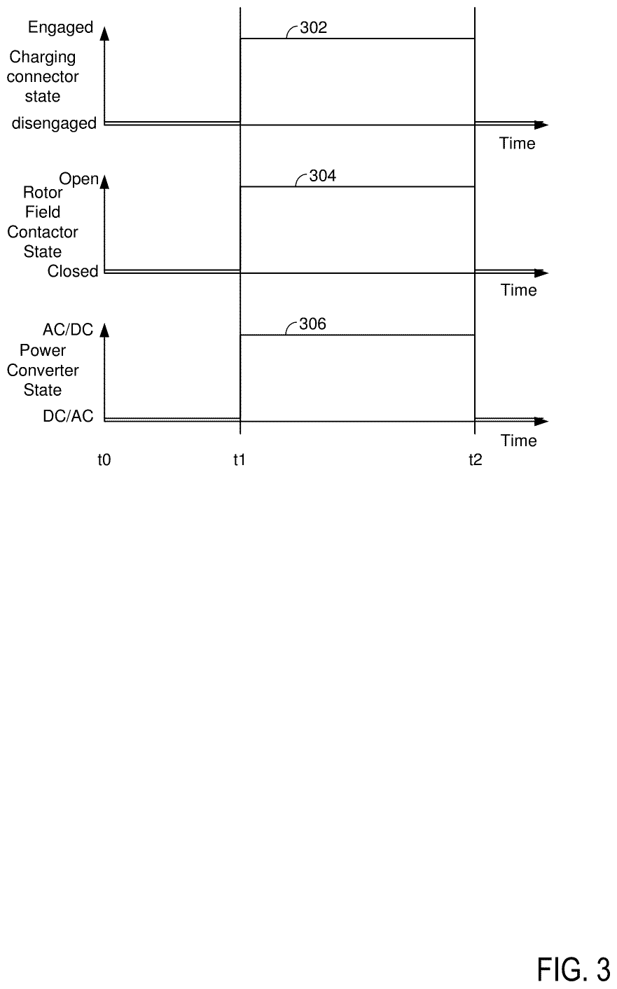

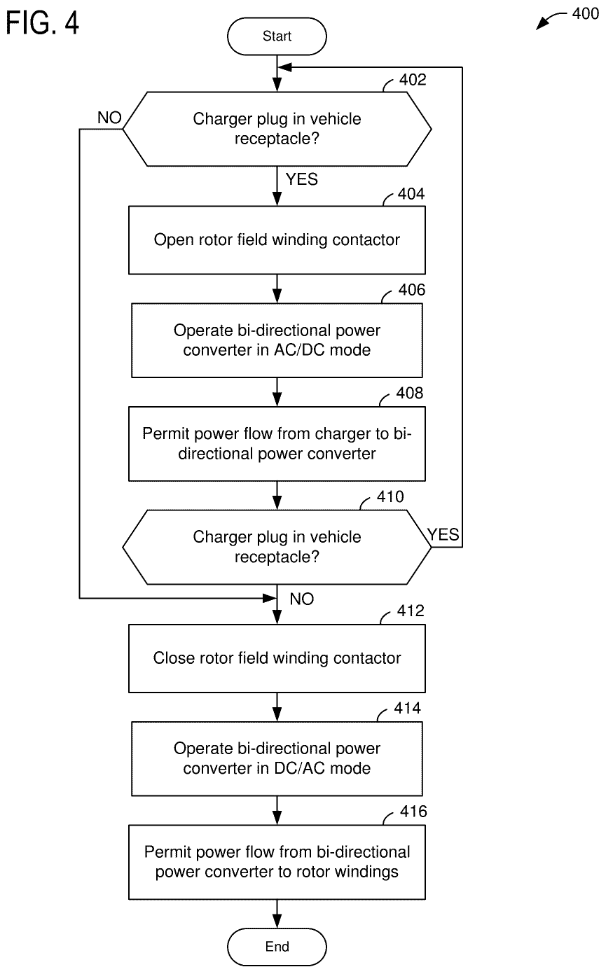

An electric power distribution system that reduces an actual total number of power converters in an electric vehicle is shown. The electric power distribution system applies a bi-directional power converter to convert electrical grid sourced power to DC and applies the same bi-directional power converter to supply AC power to rotor windings of a traction motor. The electric power system may be included in an electric vehicle as shown in FIG. 1. The electric power distribution system may be configured as shown in FIG. 2. An operating sequence for the power distribution system is shown in FIG. 3. Finally, a method for operating the electric power distribution system is shown in FIG. 4.

FIG. 1 illustrates an example electric vehicle 10. In FIG. 1 mechanical connections between the various components are illustrated as solid lines, whereas electrical connections between various components are illustrated as dashed lines. Vehicle front end is indicated at 110 and vehicle rear end is indicated at 111. Electric vehicle 10 travels in a forward direction when vehicle front end 110 leads movement of electric vehicle 10. Electric vehicle 10 travels in a reverse direction when vehicle rear end 111 leads movement of electric vehicle 10. In this example, electric vehicle 10 is a rear wheel drive vehicle, but in other examples, electric vehicle 10 may be a four-wheel drive or front wheel drive vehicle.

Electric vehicle 10 includes a propulsion source 105 (e.g., an electric machine, such as a motor), but in other examples two or more propulsion sources may be provided. In one example, propulsion source 105 may be a synchronous electric machine that may operate as a motor or generator. In other examples, propulsion source 105 may be a direct current (DC) machine. Electric vehicle 10 also includes a transmission 135. The propulsion source 105 is fastened to the transmission 135 and propulsion source 105 delivers power from its rotor 105a to transmission 135. Transmission 135 may be mechanically coupled to differential gears. Differential gears 106 may be coupled to two axle shafts, including a first or right axle shaft 190a and a second or left axle shaft 190b. Electric vehicle 10 further includes front wheels 102 and rear wheels 103.

The transmission 135 may be referred to as a step ratio transmission, or alternatively, a different configuration. Transmission 135 may include one or more clutch actuators (not shown) to shift one or more clutches. In this example, electric power inverter 115 (e.g., a power converter) is electrically coupled to propulsion source 105 to convert DC power to alternating current (AC) and vise-versa. Powertrain controller 116 is electrically coupled to sensors 117 and actuators of electric vehicle 10. For example, sensors 117 may include, but are not limited to inverter switch temperature sensors, electric machine winding temperature sensors, bus bar temperature sensors, etc.

Transmission 135 may transfer mechanical power to or receive mechanical power from differential gears 106. Differential gears 106 may transfer mechanical power to or receive mechanical power from rear wheels 103 via right axle shaft 190a and left axle shaft 190b. Propulsion source 105 may consume alternating current (AC) electrical power provided via electric power inverter 115. Alternatively, propulsion source 105 may provide AC electrical power to electric power inverter 115. Electric power inverter 115 may be provided with high voltage direct current (DC) power from battery 160 (e.g., a traction battery, which also may be referred to as an electric energy storage device or battery pack). Electric power inverter 115 may convert the DC electrical power from battery 160 into AC electrical power for propulsion source 105. Alternatively, electric power inverter 115 may be provided with AC power from propulsion source 105. Electric power inverter 115 may convert the AC electrical power from propulsion source 105 into DC power to store in battery 160.

Propulsion source 105 may transfer mechanical power to or receive mechanical power from transmission 135. As such, transmission 135 may be a multi-speed gear set that may shift between gear ratios when commanded via powertrain controller 116. Powertrain controller 116 includes a processor 116a and memory 116b. Memory 116b (e.g., storage media) may include read exclusive memory, random access memory, and keep alive memory. The memory may be programmed with computer readable data representing instructions that are executable by a processor for performing the methods and control techniques described herein as well as other variants that are anticipated but not specifically listed. As such, control techniques, methods, and the like expanded upon herein may be stored as instructions in non-transitory memory.

Battery 160 may periodically receive electrical energy from a power source such as a stationary power grid 5 residing external to the vehicle (e.g., not part of the vehicle). As a non-restricted example, electric vehicle 10 may be configured as a plug-in electric vehicle (EV), whereby electrical energy may be supplied to battery 160 via the stationary power grid 5 and charging station 12. Electric charge may be delivered to battery 160 via vehicle charging connector 100 (e.g., a receptacle) and bi-directional power converter 159.

Battery 160 may include a BMS controller 139 (e.g., a battery management system controller) and an electrical power distribution box 162. BMS controller 139 may provide charge balancing between energy storage elements (e.g., battery cells) and communication with other vehicle controllers (e.g., vehicle control unit 152). BMS controller 139 includes a core processor 139a and memory 139b (e.g., random-access memory, read-exclusive memory, and keep-alive memory).

Electric vehicle 10 may include a vehicle control unit (VCU) 152 that may communicate with electric power inverter 115, powertrain controller 116, friction or foundation caliper controller 170, global positioning system (GPS) 188, BMS controller 139, and dashboard 186 and components included therein via controller area network (CAN) 120. VCU 152 includes memory 114, which may include read-exclusive memory (ROM or non-transitory memory) and random access memory (RAM). VCU also includes a digital processor or central processing unit (CPU) 153, and inputs and outputs (I/O) 118 (e.g., digital inputs including counters, timers, and discrete inputs, digital outputs, analog inputs, and analog outputs). VCU may receive signals from sensors 154 and provide control signal outputs to actuators 156. Sensors 154 may include but are not restricted to lateral accelerometers, longitudinal accelerometers, yaw rate sensors, inclinometers, temperature sensors, battery voltage and current sensors, and other sensors described herein. Additionally, sensors 154 may include steering angle sensor 197, driver demand pedal position sensor 141, vehicle range finding sensors including radio detection and ranging (RADAR), light detection and ranging (LIDAR), sound navigation and ranging (SONAR), and caliper application pedal position sensor 151. Actuators may include but are not constrained to inverters, transmission controllers, display devices, human/machine interfaces, friction caliper systems, and battery controller described herein.

Driver demand pedal position sensor 141 is shown coupled to driver demand pedal 140 for determining a degree of application of driver demand pedal 140 by human 142. Caliper application pedal position sensor 151 is shown coupled to caliper application pedal 150 for determining a degree of application of caliper application pedal 150 by human 142. Steering angle sensor 197 is configured to determine a steering angle according to a position of steering wheel 198.

Electric vehicle 10 is shown with a global position determining system 188 that receives timing and position data from one or more GPS satellites 189. Global positioning system may also include geographical maps that are stored in ROM for determining the position of electric vehicle 10 and features of roads that electric vehicle 10 may travel on.

Electric vehicle 10 may also include a dashboard 186 that an operator of the vehicle may interact with. Dashboard 186 may include a display system 187 configured to display information to the vehicle operator. Display system 187 may comprise, as a non-restricting example, a touchscreen, or human machine interface (HMI), display which enables the vehicle operator to view graphical information as well as input commands. In some examples, display system 187 may be connected wirelessly to the internet (not shown) via VCU 152. As such, in some examples, the vehicle operator may communicate via display system 187 with an internet site or software application (app) and VCU 152.

Dashboard 186 may further include an operator interface 182 via which the vehicle operator may adjust the operating status of the vehicle. Specifically, the operator interface 182 may be configured to activate and/or deactivate operation of the vehicle driveline (e.g., propulsion source 105) based on an operator input. Further, an operator may request an axle mode (e.g., park, reverse, neutral, drive) via the operator interface. Various examples of the operator interface 182 may include interfaces that utilize a physical apparatus, such as a key, that may be inserted into the operator interface 182 to activate the electric vehicle 10 including propulsion source 105 and to turn on the electric vehicle 10. The apparatus may be removed to shut down the transmission 135 and propulsion source 105 to turn off electric vehicle 10. Propulsion source 105 may be activated via supplying electric power to propulsion source 105 and/or electric power inverter 115. Propulsion source 105 may be deactivated by ceasing to supply electric power to propulsion source 105 and/or electric power inverter 115. Still other examples may additionally or optionally use a start/stop button that is manually pressed by the operator to start or shut down the propulsion source 105 to turn the vehicle on or off. In other examples, a remote electrified axle or electric machine start may be initiated remote computing device (not shown), for example a cellular telephone, or smartphone-based system where a user's cellular telephone sends data to a server and the server communicates with the vehicle control unit 152 to activate the inverter 115 and propulsion source 105. Spatial orientation of electric vehicle 10 is indicated via axes 175.

Electric vehicle 10 is also shown with a foundation or friction caliper controller 170. Friction caliper controller 170 may selectively apply and release friction calibers (e.g., 172a and 172b) via allowing hydraulic fluid to flow to the friction calipers. The friction calipers may be applied and released so as to reduce locking of the friction calipers to front wheels 102 and rear wheels 103. Wheel position or speed sensors 161 may provide wheel speed data to friction caliper controller 170. Electric vehicle 10 may provide torque to rear wheels 103 to propel electric vehicle 10.

A human or autonomous driver 142 may request a driver demand wheel torque, or alternatively a driver demand wheel power, via applying driver demand pedal 140 or via supplying a driver demand wheel torque/power request to vehicle control unit 152. Vehicle control unit 152 may then demand a torque or power from propulsion source 105 via commanding powertrain controller 116. Powertrain controller 116 may command electric power inverter 115 to deliver the driver demand wheel torque/power via electrified axle 190 and propulsion source 105. Electric power inverter 115 may convert DC electrical power from battery 160 into AC power and supply the AC power to propulsion source 105. Propulsion source 105 rotates and transfers torque/power to transmission 135. Transmission 135 may supply torque from propulsion source 105 to differential gears 106, and differential gears 106 transfer torque from propulsion source 105 to rear wheels 103 via axle shafts 190a and 190b.

During conditions when the driver demand pedal is fully released, vehicle control unit 152 may request a small negative or regenerative power to gradually slow electric vehicle 10 when a speed of electric vehicle 10 is greater than a threshold speed. The amount of regenerative power requested may be a function of driver demand pedal position, battery state of charge (SOC), vehicle speed, and other conditions. If the driver demand pedal 140 is fully released and vehicle speed is less than a threshold speed, vehicle control unit 152 may request a small amount of positive torque/power (e.g., propulsion torque) from propulsion source 105, which may be referred to as creep torque or power. The creep torque or power may allow electric vehicle 10 to remain stationary when electric vehicle 10 is on a small positive grade.

The human or autonomous driver may also request a negative or regenerative driver demand slowing torque, or alternatively a driver demand slowing power, via applying caliper pedal 150 or via supplying a driver demand slowing power request to vehicle control unit 152. Vehicle control unit 152 may request that a first portion of the driver demanded slowing power be generated via propulsion source 105 via commanding powertrain controller 116. Additionally, vehicle control unit 152 may request that a portion of the driver demanded slowing power be provided via friction calipers 172a and 172b via commanding friction caliper controller 170 to provide a second portion of the driver requested slowing power.

After vehicle control unit 152 determines the slowing power request, vehicle control unit 152 may command powertrain controller 116 to deliver the portion of the driver demand slowing power allocated to propulsion source 105. Propulsion source 105 may convert the vehicle's kinetic energy into AC power.

Powertrain controller 116 includes predetermined transmission gear shift schedules whereby fixed ratio gears of transmission 135 may be selectively engaged and disengaged. Shift schedules stored in powertrain controller 116 may select gear shift points or events as a function of driver demand wheel torque and vehicle speed.

Referring now to FIG. 2, a schematic of an example electric power distribution system 200 is shown. In this figure, electrical elements and electric conductors are indicated via solid lines.

Electric power distribution system 200 includes a vehicle charging connector 100 that is configured to receive AC power from a charger. The AC power may be two-phase or three-phase. The vehicle charging connector 100 is shown directly electrically coupled to switch 206 and bi-directional power converter 159. Herein directly electrically coupled is defined as one electric device being electrically coupled to a second electric device with no intervening electric power consumers. An electric device may be directly electrically coupled to a second electric device even though there may be connectors, terminals, or a bus between the two electric devices. Switch 206 may be a contactor, relay, switching semi-conductor (e.g., transistor, silicon controlled rectifier, etc.), or solid state switch. Bi-directional power converter 159 may operate as an AC/DC converter that converts AC electric power from a power grid to DC power for charging traction battery 160. Alternatively, bi-directional power converter 159 may operate as a DC/AC converter to convert DC electric power from traction battery 16 to AC electric power that is supplied to inductive transfer unit 204 (e.g., a transformer) and rotor windings 202 of traction motor 105. Inductive transfer unit 204 is directly electrically coupled to rotor windings 202 and switch 206. In this example, switch 204 is shown as a double pole, double through switch, but it may be appreciated that switch 202 may be comprised of two separate switches. In some examples, a single switch may be applied. Bi-directional power converter 159 is directly electrically coupled to traction battery 160. Traction battery 160 is directly electrically coupled to inverter 115 and inverter 115 is directly electrically coupled to armature windings of traction motor 105.

The system of FIGS. 1 and 2 provides for a vehicle power distribution system, comprising: a traction battery; a direct current to alternating current (DC/AC) power converter configured to supply three phase alternating current (AC) electric power to an armature of a traction motor rotor from the traction battery; and a bi-directional power converter configured to supply AC to a rotor winding of the traction motor in a first mode and supply direct current (DC) to the traction battery in a second mode. In a first example, the vehicle power distribution system includes where the DC/AC power converter and the bi-directional power converter are electrically coupled to the traction battery. In a second example that may include the first example, the vehicle power distribution system includes where the bi-directional AC/DC power converter is configured to receive two-phase AC power. In a third example that may include one or both of the first and second examples, the vehicle power distribution system includes where the bi-directional AC/DC power converter is configured to receive three-phase AC power. In a fourth example that may include one or more of first through third examples, the vehicle power distribution system includes where the bi-directional power converter is additionally coupled to a vehicle charging connector. In a fifth example that may include one or more of first through fourth examples, the vehicle power distribution system includes where the traction motor is a three-phase motor. In a sixth example that may include one or more of first through fifth examples, the vehicle power distribution system further comprises a controller including executable instructions stored in non-transitory memory that cause the controller to operate the bi-directional AC/DC power converter based on an input received via the vehicle charging connector.

The system of FIGS. 1 and 2 also provides for a vehicle power distribution system, comprising: a traction battery; a traction motor; a direct current to alternating current (DC/AC) power converter configured to supply three phase alternating current (AC) electric power to an armature of the traction motor from the traction battery; a bi-directional power converter configured to supply AC to a rotor winding of the traction motor and supply direct current (DC) to the traction battery from an AC power source; a switch electrically coupled to the AC/DC power converter; and an inductive power transfer unit electrically coupled to the switch and the rotor winding. In a first example, the vehicle power distribution system further comprises a controller including executable instructions stored in non-transitory memory that cause the controller to operate the bi-directional power converter based on a request to charge the traction battery. In a second example that may include the first example, the vehicle power distribution system further comprises additional executable instructions that cause the controller to open the switch in response to the request to charge the traction battery. In a third example that may include one or both of the first and second examples, the vehicle power distribution system further comprises additional executable instructions that cause the controller to close the switch in response to an absence of the request to charge the traction battery. In a fourth example that may include one or more of the first through third examples, the vehicle power distribution system further comprises a vehicle charging connector electrically coupled to the bi-directional power converter.

Turning now to FIG. 3, an example operating sequence for the power distribution system of FIGS. 1 and 2 is shown. The sequence of FIG. 3 may be generated via the system of FIGS. 1 and 2 in cooperation with the method of FIG. 4. The vertical lines represent times of particular interest during the sequence.

The first plot from the top of FIG. 3 is a plot of vehicle charging connector operating state versus time. The vertical axis represents vehicle charging connector state. The vehicle charging connector is disengaged from grid power when trace 302 is at a lower level near the horizontal axis. The vehicle charging connector is engaged with grid power when trace 302 is at a higher level near the vertical axis arrow. The horizontal axis represents time and time increases from the left side of the plot to the right side of the plot.

The second plot from the top of FIG. 3 is a plot of rotor field contactor operating state versus time. The vertical axis represents rotor field contactor state. The rotor field winding contactor (e.g., 206 of FIG. 2) is closed trace 304 is at a lower level near the horizontal axis. The rotor field contactor is open when trace 304 is at a higher level near the vertical axis arrow. The horizontal axis represents time and time increases from the left side of the plot to the right side of the plot.

The third plot from the top of FIG. 3 is a plot of bi-directional power converter operating state versus time. The vertical axis represents bi-directional power converter operating state. The power converter (e.g., 159 of FIG. 2) is operating as a DC/AC converter when trace 306 is at a lower level near the horizontal axis. The bi-directional power converter is operating as an AC/DC converter when trace 306 is at a higher level near the vertical axis arrow. The horizontal axis represents time and time increases from the left side of the plot to the right side of the plot.

At time t0, the vehicle charging connector is not engaged (e.g., a vehicle charger is not plugged into the vehicle charging connector) and the rotor field contactor is closed. The bi-directional power converter is operating in a DC/AC converter mode where electric power from the traction battery may be converted to AC power that is supplied to the traction motor windings. In this mode, the vehicle may be propelled via the traction motor.

At time t1, the vehicle charging connector is engaged (e.g., a vehicle charger is plugged into the vehicle charging connector) and the rotor field contactor is opened in response to the vehicle charger being plugged into the vehicle's charging connector. In addition, the bi-directional power converter switches operating modes and it begins operating in an AC/DC converter mode where electric power from the power grid may be converted to DC power that is supplied to the traction battery. In this mode, the vehicle traction battery may be charged.

At time t2, the vehicle charging connector is disengaged (e.g., a vehicle charger is no longer plugged into the vehicle charging connector) and the rotor field contactor is closed in response to the vehicle charger not being plugged into the vehicle's charging connector. Additionally, the bi-directional power converter switches operating modes and it begins operating in an DC/AC converter mode where electric power from the traction battery may be converted to AC power that is supplied to the inductive transfer unit and the rotor windings.

Thus, when a vehicle charger is plugged into a vehicle charging connector, operation of a bi-directional power supply and a switch may be changed. Further, when the vehicle charger is unplugged from the vehicle charging connector, operation of the bi-directional power supply and the switch may be changed again to different operating states.

Turning now to FIG. 4, a method for operating a power distribution system of the type shown in FIGS. 1 and 2 is shown. The method of FIG. 4 may be performed via a controller or via electric hardware (e.g., relays, switches, etc.). The method of FIG. 4 may operate as shown in the sequence of FIG. 3. If the method of FIG. 4 is performed via a controller, the controller may include executable instructions that are stored in non-transitory memory of the controller. The controller may operate sensors and actuators to change the operating state of one or more actuator devices in the real world.

At 402, method 400 judges whether or not a vehicle charger is plugged into the vehicle charging connector 100. The vehicle charger being plugged into the vehicle charging connector may be interpreted as a request to charge the vehicle. In other examples, a user may input a request to charge the vehicle via a user interface. If method 400 judges that the vehicle charger is plugged into the vehicle charging connector, or alternatively, if there is a request to charge the vehicle, the answer is yes and method 400 proceeds to 404. Otherwise, the answer is no and method 400 proceeds to 412.

At 404, method 400 opens the rotor field winding contactor (e.g., 206) to electrically isolate the traction motor rotor windings and inductive transfer unit from AC charger electric power. Method 400 proceeds to 406.

At 406, method 400 commands the bi-directional power converter (e.g., 159) to operate in an AC/DC mode so that it may converter AC power from the power grid into DC power that is supplied to the traction battery. Method 400 proceeds to 408.

At 408, method 400 the permits electric power flow from the bi-directional power converter to the traction battery. The bi-directional power converter may cease supplying power to the traction battery when the traction battery is fully charged. Method 400 proceeds to 410.

At 410, method 400 judges whether or not a vehicle charger is plugged into the vehicle charging connector 100. If method 400 judges that the vehicle charger is plugged into the vehicle charging connector, or alternatively, if there is a request to charge the vehicle, the answer is yes and method 400 returns to 402. Otherwise, the answer is no and method 400 proceeds to 412.

At 412, method 400 closes the rotor field winding contactor (e.g., 206) and proceeds to 414.

At 414, method 400 commands the bi-directional power converter (e.g., 159) to operate in a DC/AC mode so that it may converter DC power from the traction battery into AC power that is supplied to the inductive transfer unit and the rotor windings. Method 400 proceeds to 416.

At 416, method 400 the permits electric power flow from the bi-directional power converter to the rotor windings. Method 400 proceeds to exit.

Thus, method 400 provides for changing operating modes of a bi-directional power converter in response to an indication of vehicle charging or an indication of a request to charge the vehicle. Further, method 400 may electrically isolate rotor windings and an inductive transfer unit from AC grid power when the vehicle's traction battery is being charged and/or when there is a request to charge the vehicle's traction battery.

The method of FIG. 4 provides for a method for distributing electric power of a vehicle, comprising: supplying direct current (DC) electric power to a traction battery via a bi-directional AC/DC power converter during a first condition; and supplying alternating current (AC) electric power to a rotor of a traction motor via the bi-directional AC/DC power converter during a second condition. In a first example, the method includes where the first condition is a vehicle charging connector interfacing with a vehicle connector. In a second example that may include the first example, the method includes where the second condition is the vehicle charging connector not interfacing with the vehicle connector. In a third example that may include one or both of the first and second examples, the method includes where the first condition is based on a request to charge a traction battery. In a fourth example that may include one or more of the first through third examples, the method includes where the second condition is based on an absence of the request to charge the traction battery. In a fifth example that may include one or more of the first through fourth examples, the method further comprises closing a switch to supply AC electric power to the rotor. In a sixth example that may include one or more of the first through fifth examples, the method further comprises opening the switch to supply DC electric power to the traction battery. In a seventh example that may include one or more of the first through sixth examples, the method further comprises supplying electric power to an armature of the traction motor via the traction battery.

While various embodiments have been described above, it may be understood that they have been presented by way of example, and not limitation nor restriction. It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The technology may be used as a stand-alone, or used in combination with other power transmission systems not limited to machinery and propulsion systems for tandem axles, electric tag axles, P4 axles, HEVs, BEVs, agriculture, marine, motorcycle, recreational vehicles and on and off highway vehicles, as an example. The subject matter of the present disclosure includes all novel and non-obvious combinations and sub-combinations of the various systems and configurations, and other features, functions, and/or properties disclosed herein. It will be apparent to persons skilled in the relevant arts that the disclosed subject matter may be embodied in other specific forms without departing from the spirit of the subject matter.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

As used herein, the term “approximately” is construed to mean plus or minus five percent of the range, unless otherwise specified.

1. A vehicle power distribution system, comprising:
a traction battery;
a direct current to alternating current (DC/AC) power converter configured to supply three-phase alternating current (AC) electric power to an armature of a traction motor from DC electric power of the traction battery; and
a bi-directional power converter configured to supply AC to a rotor winding of the traction motor in a first mode and supply direct current (DC) to the traction battery in a second mode, where the bi-directional power converter is configured to operate as either an AC/DC converter that converts AC electric power from a power grid to DC power for charging the traction battery or as a DC/AC converter to convert DC electric power from the traction battery to AC electric power that is supplied to an inductive transfer unit and the rotor winding of the traction motor.

2. The vehicle power distribution system of claim 1, where the DC/AC power converter and the bi-directional power converter are electrically coupled to the traction battery.

3. The vehicle power distribution system of claim 1, where the bi-directional power converter is configured to receive two-phase AC power.

4. The vehicle power distribution system of claim 1, where the bi-directional power converter is configured to receive three-phase AC power.

5. The vehicle power distribution system of claim 1, where the bi-directional power converter is additionally electrically coupled to a vehicle charging connector.

6. The vehicle power distribution system of claim 5, where the traction motor is a three-phase motor.

7. The vehicle power distribution system of claim 6, further comprising a controller including executable instructions stored in non-transitory memory that cause the controller to operate the bi-directional power converter based on an input received via the vehicle charging connector.

8. A method for distributing electric power of a vehicle, comprising:
supplying direct current (DC) electric power to a traction battery via a bi-directional power converter during a first condition; and
supplying alternating current (AC) electric power to a rotor of a traction motor via the bi-directional power converter during a second condition,
where the bi-directional power converter is configured to operate as either an AC/DC converter that converts AC electric power from a power grid to DC power for charging the traction battery or as a DC/AC converter to convert DC electric power from the traction battery to AC electric power that is supplied to an inductive transfer unit and the rotor of the traction motor.

9. The method of claim 8, where the first condition is a vehicle charging connector interfacing with a vehicle connector.

10. The method of claim 9, where the second condition is the vehicle charging connector not interfacing with the vehicle connector.

11. The method of claim 8, where the first condition is based on a request to charge the traction battery.

12. The method of claim 11, where the second condition is based on an absence of the request to charge the traction battery.

13. The method of claim 8, further comprising closing a switch to supply AC electric power to the rotor.

14. The method of claim 13, further comprising opening the switch to supply DC electric power to the traction battery.

15. The method of claim 14, further comprising supplying electric power to an armature of the traction motor via the traction battery.

16. A vehicle power distribution system, comprising:
a traction battery;
a traction motor;
a direct current to alternating current (DC/AC) power converter configured to supply three phase alternating current (AC) electric power to an armature of the traction motor from the traction battery;
a bi-directional power converter configured to supply AC to a rotor winding of the traction motor in a first mode and supply direct current (DC) to the traction battery from an AC power source in a second mode, where the bi-directional power converter is configured to operate as either an AC/DC converter that converts AC electric power from a power grid to DC power for charging the traction battery or as a DC/AC converter to convert DC electric power from the traction battery to AC electric power that is supplied to an inductive transfer unit and the rotor winding of the traction motor;
a switch electrically coupled to the bi-directional power converter; and
an inductive power transfer unit electrically coupled to the switch and the rotor winding.

17. The vehicle power distribution system of claim 16, further comprising a controller including executable instructions stored in non-transitory memory that cause the controller to operate the bi-directional power converter based on a request to charge the traction battery.

18. The vehicle power distribution system of claim 17, further comprising additional executable instructions that cause the controller to open the switch in response to the request to charge the traction battery.

19. The vehicle power distribution system of claim 18, further comprising additional executable instructions that cause the controller to close the switch in response to an absence of the request to charge the traction battery.

20. The vehicle power distribution system of claim 19, further comprising a vehicle charging connector electrically coupled to the bi-directional power converter.
